(19) United States
(12) Patent Application Publication
(10) Pub. No.: US 2007/0264890 A1
(43) Pub. Date: Nov. 15, 2007

(54) Underwater lifting device

(76) Inventor: Gaylen L. Brown, Snohomish, WA (US)

Correspondence Address: DOWREY RICKARDS, 19119 NORTHCREEK PARKWAY, SUITE 106, BOTHELL, WA, 98011, US

(21) Appl. No.: 11/408,759

(22) Filed: Apr. 21, 2006

(51) Int. Cl. B63B 22/22; A01K 69/06

(52) U.S. Cl. 441/30; 43/102

(57) ABSTRACT

A lift device may comprise a housing containing a lift bag and a tank containing a working gas. The lifting device may be attached between a lift line descending from the surface of a body of water and a submerged object to be raised. A gas release mechanism that forms a part of the lifting device may cause the tank to emit a gas in response to tension on the lift line to fill the lift bag and float the object to the surface.

### BACKGROUND

In some areas, such as the Puget Sound region of Washington, United States, crab and shrimp pots may be placed at depths of up to about 400 feet (122 m). Many such cages have bottoms, sides and top made of wire, plastic or polymer mesh, netting or grids. In both sport and commercial fishery, multiple pots may be placed from a single vessel in multiple locations. The pots are allowed to sink to the seabed with ropes or cables attached. Floats or buoys are attached to the free ends of these rope or cable lines so that the pots may be drawn up from the seabed at a later time.

In sports fishery, many fishers pull pots manually, drawing in the line hand over hand. It is not uncommon for such shrimp or crab pots to weight between 15 and 40 pounds (about 7 to 18 kg). While this is not an insurmountable weight to lift, the raising of the pot also involves overcoming the hydrodynamic drag generated as the pot is pulled through the water. As this drag increases with increased velocity of the pot through the water, the drag can significantly increase the effort required to raise the pot, as well as the time over which such effort must be expended.

Many commercial vessels and some sports fishery vessels employ booms and winches for hauling the pots to the surface. Such booms and winches are costly and, particularly in sports fishery vessels, may interfere with other uses of the vessel, or may require significant time and effort to install and remove. Such boom and winch systems may raise the pots at the rate of about 80 feet per minute (24 meters per minute).

Another method of raising the pots, used primarily in the sports fishery, employs the boat's motion to raise the pot. According to this method, a pulley or sheave is attached to a float and the line from the pot is run through the pulley and attached to a cleat on the boat. The engine is then engaged, and the drag of the crab pot and the float moving through the water as the boat moves forward pulls the line through the pulley connected to the float. Backward travel of the line through the pulley is restricted so that once the pot is pulled to the surface, it does not sink back toward the seabed once the motion of the boat ceases. The boat may then circle back to the location of the float and retrieve the float and pot. This method, of course, may require significant open water in which the boat can run, and increases the fuel consumption of the boat as compared to raising the pot with a winch or by hand.

### BRIEF DESCRIPTION OF THE DRAWINGS

FIG. 1 is a schematic isometric drawing of a crab or shrimp pot resting on the seabed and attached to a lifting apparatus.

FIG. 2 is a schematic isometric drawing depicting the first stage of raising of the pot in which inflation of the float of the lifting apparatus has commenced.

FIG. 3 is a schematic isometric drawing of a pot with attached lifting device with the float inflated.

FIG. 4 is a schematic isometric drawing of a pot with attached lifting device shown at the surface of the water.

FIG. 5 is an isometric view of a lifting device.

FIG. 6 is an exploded isometric view of a lifting device of FIG. 5.

FIGS. 7 and 8 are sectional side views of a lifting device

FIGS. 9 and 10 are sectional side views of a lifting device in different stages of operation.

FIG. 11 is a sectional view of the lifting device of FIG. 9 with parts broken away.

### DETAILED DESCRIPTION

Objects such as crab, shrimp, lobster and other fishing apparatus, scientific apparatus and so forth may be sunk to the seabed, lake bed, river bed, or some other location in a body of water. For purposes of this application, the term “seabed” will be used, but those skilled in the art will recognize the utility hereof in connection with such other bodies of water. Similarly, although it may be desirable to lower any of a variety of articles into a body of water for later retrieval, the embodiments of the present application will reference crab and shrimp pots for purposes of explanation with the understanding that they may be used for retrieval of other objects.

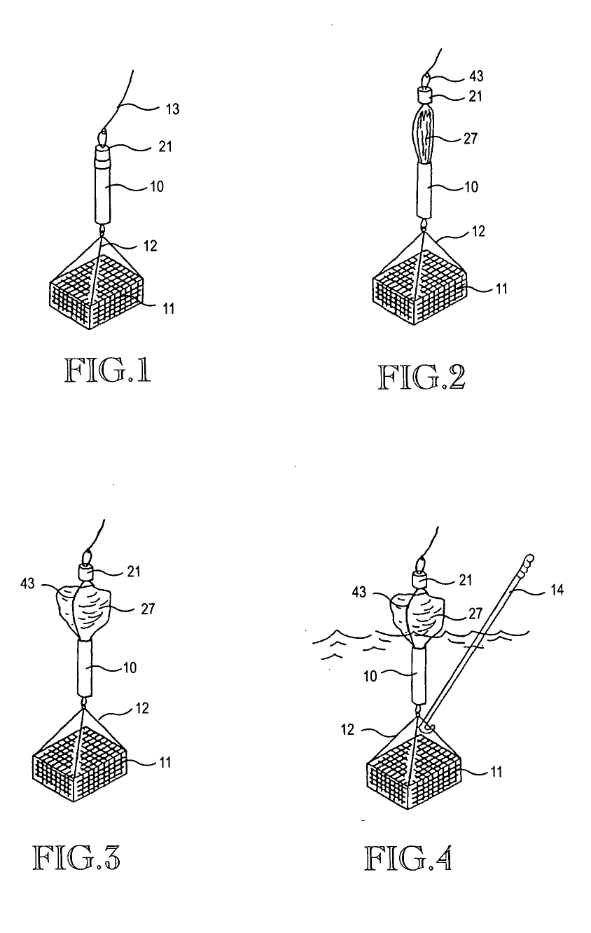

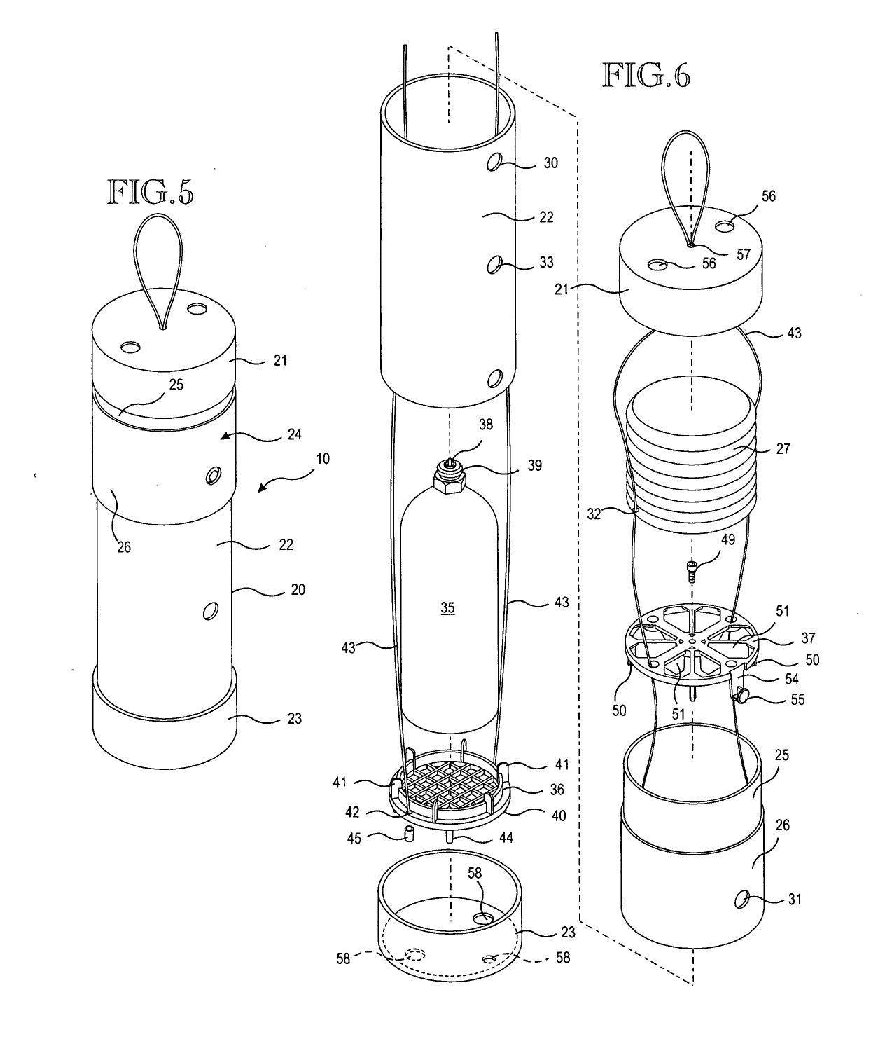

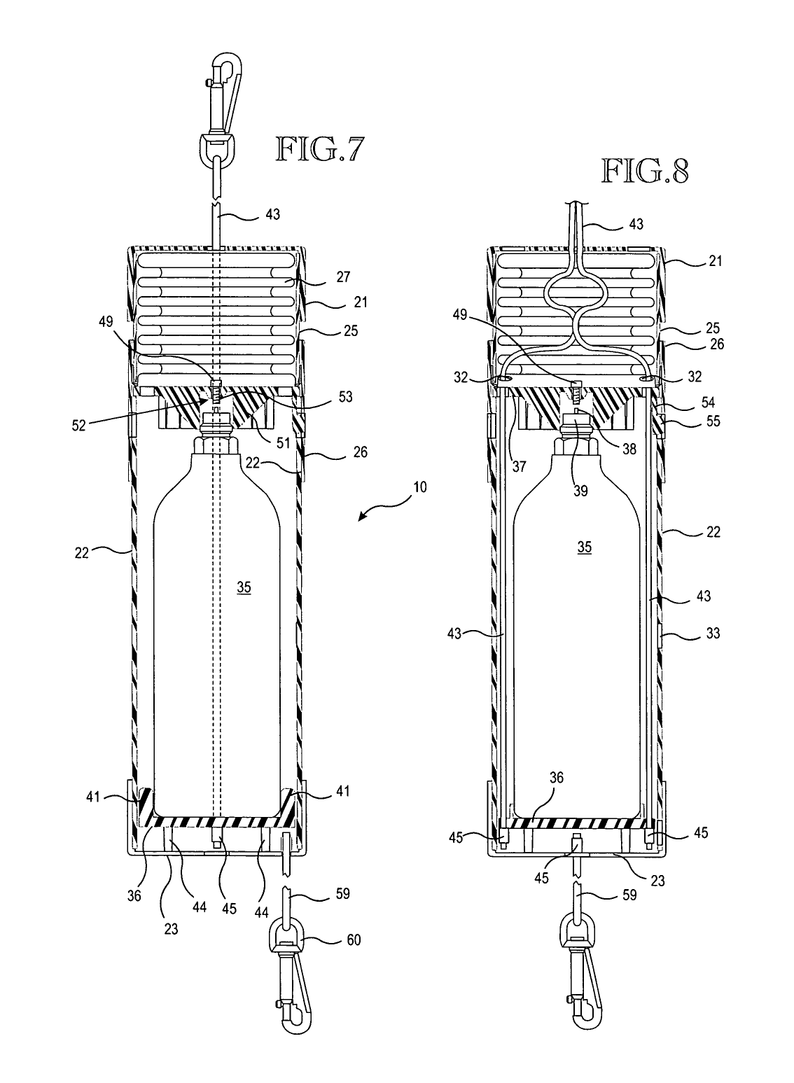

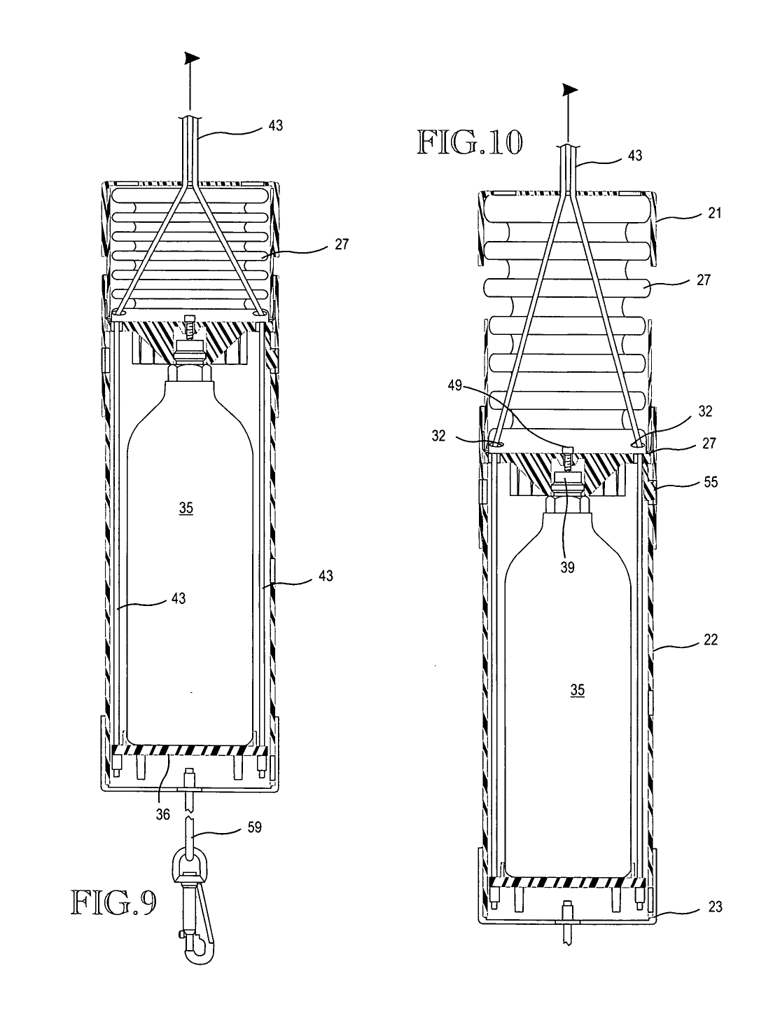

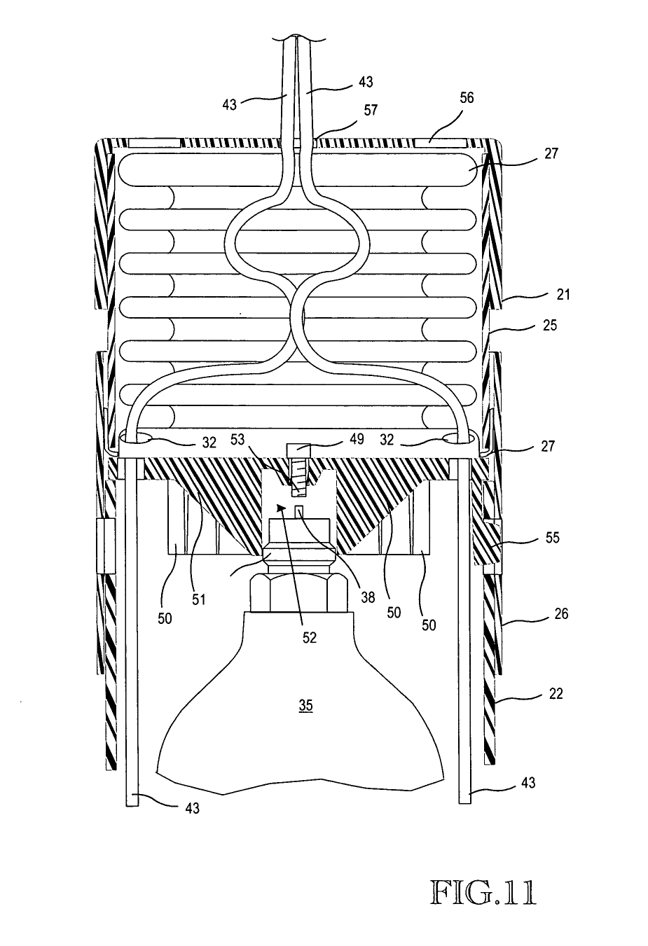

According to one embodiment, the object to be raised may be a shrimp or crab pot 11, scientific instrument, or other such article. Referring to FIGS. 1-4, a lifting device 10 may be fastened directly to the pot 11, or may be attached by one or more lengths of cable or rope lines 12, as illustrated. Referring to FIGS. 5-11, a lifting device 10 according to one embodiment may comprise a housing 20 that may serve as an attachment structure for affixing the lifting device to the pot 11 and for connecting and supporting various of the components of the lifting device 10. The housing 20 may be closed with an end cap 21. The body 20 may comprise a main body tube 22 closed off at its lower end by a base cap 23 that may be permanently or removably attached to the main body tube 22. The main body tube 22 and base cap 23 may be of any suitable material, but in the present embodiment are made of PVC (polyvinyl chloride) plastic. This plastic material is resistant to fresh and salt water and may be joined to like material by any of a variety of means, such as solvent welding, friction welding, adhesives, threaded engagement, screws or other fasteners, and so forth.

The housing 20 may also comprise a lift bag chamber 24 that is demountable from the body tube 22 and that, in turn, may be comprised of an upper tubular member 25 and lower tubular member 26. The outside diameter of the upper tubular member 25 being approximately equal to the inner diameter of the lower tubular member 26 so that the one fits inside the other. The lift bag chamber 25 is of size sufficient to contain the lift bag 27 that serves as a receptacle for a working gas, when the lift bag 27 is in its uninflated state and may further be sized to allow a quantity of rope or other line to be retained therein as described below.

The lift bag 27 may be of a relatively thin flexible material, such as an approximately 0.5-2 mil plastic bag. Many different materials may be used, alone or in combination, to make the bag. High density polyethylene is one material that may be used.

The open end of the bag may be passed through the upper tube 25 comprising the lift bag chamber 24 and lapped back over its outer surface. If the tolerance between the upper and lower tubes 25, 26 is sufficiently small, the upper tube 25, with the mouth of the bag lapped over it, may be forced into the lower tube 26 to mount the upper tube 25 in the lower tube 26 to achieve a strong friction fit that may be overcome, for example to change the lift bag 27, by the application of sufficient force. The force required to overcome such a friction fit, of course, should be greater than the maximum force that the lift bag can generate.

Other means may be used to mount the bag, such as a collar that captures the lower, open end of the lift bag 27 and that is removably mountable to the body tube 22 or even the valve actuator 37 that is discussed below. The lift bag 27 could also be permanently mounted to the lift bag chamber 25. The body tube 22 and the lower tube of the lift bag chamber both include apertures 30 and 31 of corresponding size that may be radially aligned with one another when the lift bag chamber 24 is mounted on the body tube 22 of the housing. The body tube may have other apertures

Several components may be positioned in the housing 20 of the lifting device 11 of the present embodiment. A tank 35 of sufficient capacity to provide a quantity of working gas to fill the lift bag 27 to the desired extent one or more times may be positioned in the housing 20 on top of a force applier such as a lifter 36 and beneath a valve actuator 37. The tank of the present embodiment may contain carbon dioxide under pressure in liquid form, which will evaporate to its gaseous state when released. The tank 35 may have a push-type valve axially aligned with the long axis of the tank 35 wherein sufficient pressure applied to the protruding stem 38 causes the release of the working gas contained in the tank 35.

In one embodiment, the lifter 36 may comprise a plate of a suitable material, such as a plastic, that is of sufficient strength to withstand the upward force that may be applied by the lanyard 43, that serves as a connector between a lift line and the lifter, and the tank 35 to lift the pot 11 from the seabed without the aid of an inflated lift bag 27 or other gas receptacle that can receive and contain a quantity of working gas. The center portion of the lifter 36 may be perforate to allow water to drain through it, as by being in the form of a lattice or mesh having sufficient strength to support the tank 35 during the actuation and lifting process.

The outer annulus 40 of the lifter 36 may include a plurality of upstanding tabs 41 about its periphery that may serve to center the base of the tank on the lifter 36. Two diametrically-opposed holes 42 of a size sufficient for a lifting lanyard 43 to be passed through may be formed in the annulus 40 of the lifter 36. A plurality of legs 44 may extend downward from the lower surface of the lifter 36 to support it at a level above the inner surface of the base cap 23, and may also aid in maintaining the axial alignment of the lifter with the body 20. The free ends of the lanyard 43 may be inserted through the holes 42 in the annulus 40 on either side of the lifter 36 and secured in place by ferrules 45 or knots of a size greater than the diameter of the holes 42. The lanyard 45 may also be inserted through the holes 42 and looped back to the upper side of the lifter 36, where it may be tied to itself at a point above the lifter 36 to form a closed loop that passes through the associated holes 42.

As described above, according to one embodiment, the open end of the lift bag 27 may be passed through the upper tube 25 of the lift bag chamber 24. As a lift bag 27 thus connected to the lift bag chamber 24 effectively seals off the upper end of the housing 20, apertures 32 may be formed in the lift bag 27 proximate the open lower end of the lift bag 27 to permit the two legs of the lanyard 43 to pass from the interior of the lift bag 27 to its exterior. As such, most of the bag 27 may be filled with, and capture, working gas released from the tank 35.

The valve actuator 37 may include a plurality of downwardly-extending legs 50 distributed about its periphery that may stabilize the body of the valve actuator 37 from tipping out of axial alignment with the housing 20. A plurality of radially-extending vanes may descend from the lower surface of the valve actuator 37 and define a valve-receiving channel 52 into which the valve body 39 of the tank 35 may be extended. The center of the valve actuator 37 may protrude downwardly to provide a stem-engaging finger 53. In the present embodiment, the finger 53 may comprise the end portion of a screw 49 threaded through the center of the valve actuator 37, but may also comprise a metal stud or rivet that extends downward from the center of the valve actuator, or may merely be a protrusion formed integrally with the valve actuator 37.

The finger 53 may be so positioned that the movement of the tank 35 and valve actuator 37 toward one another may cause the stem 38 of the valve body 39 to contact and be depressed by the finger 53, thereby releasing the working gas from the tank 35. The vanes 51 of the valve actuator 37 that may form a channel 52 into which the valve body 39 can be inserted, may aid in guiding the valve body 39 during upward movement relative to the valve actuator 37 so that the finger 53 contacts and depresses the valve stem 38. A spring or other resilient member may act between the valve actuator 37 and the valve body 39 to increase the force required to bring the finger 53 of the valve actuator 37 into gas-releasing contact with the valve stem 38. The lifter 36 and valve actuator 37 thus comprise a gas release mechanism that may act on the tank 35 and valve stem 38 to cause the release of working gas from the tank 35.

The valve actuator 37 of the present embodiment further includes a retainer arm 54 extending downward from its periphery. A release button 55 extends outward from the distal end of the retainer arm 54, and is positioned so that, when the valve actuator 37 is placed in its proper position in the housing 20 and the apertures 30, 31 in the body tube 22 and lift bag chamber 24 are aligned, the release button 55 on the retaining arm 54 of the valve actuator may extend through both apertures 30, 31 to secure the body tube 22 of the housing 20 and the lift bag chamber 24 together. The retainer arm 54 may be sufficiently flexible that the release button 55 may be depressed inwardly of the housing 20 sufficiently to release the valve actuator 37 from the lift bag chamber 24 and housing 20.

In FIGS. 8-11, the lanyard is shown in its upwardly-drawn position. It will be appreciated by those skilled in the art that, in order for the end cap 21 to be raised off the housing sufficiently to allow expansion of the lift bag 27, as shown in FIGS. 3 and 4, the lanyard 43 must be of a sufficient length. A portion of the length of the lanyard 43, accordingly, may be stored in the lift bag chamber 24 prior to actuation, so that only a small portion protrudes upward through the cap, as shown in FIG. 1.

The cap 21 that seals the upper end of the housing 20 may have a pair of lanyard apertures 56 adjacent its outer edge, or, as shown in FIG. 1, the center aperture 57 may be formed with such a size that the two legs of the lanyard 43 may pass therethrough. The lanyard 43 may comprise two lengths of line, rope or cable or the like that may be fastened together above the cap 21, or may simply be a single length that extends upward from one of the holes 42 of the lifter 36 through the center aperture 57 in the cap 21 and back down through the center aperture 57 to the opposite hole 42 in the lifter.

The base cap 23 may be permanently secured to the housing 22, and may comprise a plurality of holes 58 through which water can drain. One or more of the holes 58 may serve to facilitate attachment of a tether 59 to the base cap. The tether 59 may be secured from being pulled out of the end cap 23 by the use of a ferrule 45 that may be crimped, glued, formed integrally with or otherwise secured to the upper end of the tether 49. The pot 11 may be fastened to the tether 59 by means of a clip 60, by tying, or by other suitable means.

Referring to FIGS. 1-4, 9 and 10, the sequence of operation of the lifting device 10 is as follows. The pot 11 or other object to be raised may be fastened to the tether 59 of the lifting device 10 that, in turn, may be fastened by the lanyard 43 to one end of the main line 13. A buoy may be attached at the other end of the main line. The pot 11 may then be dropped from a vessel and allowed to sink to the bottom of the water, such as a lake bed or sea bed. The lifting device 10 may contain sufficient air, such as air trapped in the lift bag 27, or other floatation, or otherwise be constructed such that the lifting device 10 is positively buoyant. As such, the lifting device 10 may aid in maintaining the orientation of the pot 11 as it descends to the bottom. The lift line 13 is allowed to play out as the pot 11 sinks. A locator buoy may be attached to the free end of the lift line 13, allowing the user to depart the area, for example to set or recover other pots 11, and thereafter to return and locate the position at which the pot 11 has been dropped.

According to one embodiment, when the user wishes to recover the pot 11, the user may retrieve the buoy, if used, and begin pulling upward on the lift line 13. Upon applying sufficient force to the lift line 13, as shown in FIGS. 9-11, an upward force is applied to the lanyard 43 that extends it to its full length above the lifting device. The continued application of sufficient force, in turn, urges the lifter 36 toward the top of the housing 20. This force actuates the gas release mechanism by causing the lifter 36 to lift the tank 35 so that the valve stem 38 is forced into contact with the finger 53. When sufficient pressure is applied between the finger 53 and valve stem 38, the valve in the valve body 39 opens and releases the working gas. The working gas travels upward through apertures in the valve actuator and passes into the lift bag 27, which begins to expand the bag (see FIG. 2). The lanyard 43 thus acts as an operating force transmitter to the lifter 36 of the gas release mechanism that may be used to apply a valve operating force to urge the valve stem 38 and the valve actuator 37 into gas-releasing engagement, as well as a connector between the lift line 13 and lifter 36. If the end cap 21 has not been removed by the act of the upward pull on the lanyard 43 by the lift line 13, the continued pulling on the lift line may continue release of the gas until the lift bag 27 has sufficient floatation to lift the end cap 21 off the lift bag chamber 24 of the lifting device 10. Continued pulling on the lift line 13 may aid in dislodging the pot 11 or the like from the seabed, and will continue the expelling of gas from the cylinder 35.

Once sufficient working gas has entered the lift bag to achieve positive buoyancy for the lifting device 10 and pot 11, the tension on the lift line may be released. At this point, if the user has employed a lift line that can float, the upward progress of the lifting device 10 and pot 11 may be monitored by watching the accumulation of the lift line floating on the surface.

As the lifting device 10 and pot 11 move upward through the water, the water pressure decreases and the working gas in the lift bag 27 expands. If the lift bag 27 is not completely filled with the working gas, the lift bag may continue to expand. Once the lift bag 27 has reached its capacity, any further expansion of the gas may result in its release through apertures, including, for example, the apertures 32 in the lift bag 27 through which the lanyard 43 passes, any gaps between the lift bag chamber and the body tube 22, and even, perhaps, through an aperture 33 in the body tube 22. Such outflow of working gas from the lift bag 27 may reduce the risk of the lift bag 27 rupturing due to overfilling.

The lifting device 10 continues to raise the pot 11 through the water (see FIG. 3) until the lift bag 27 has risen to the surface (see FIG. 4), whereupon the lifting device 10 and pot 11 may be recovered, for example, with the use of a hooked staff 14 (see FIG. 4) such as a boat hook, or otherwise as may be desired.

After recovery of the pot 11, and if there remains sufficient working the lifting device 10 may be reassembled for use by draining it, as through the holes 33, 58 in the body tube 22 and base cap 23, by restowing the lift bag 27 and lanyard 43 in the lift bag chamber 24 and replacing the end cap 21.

If the tank 35 of the recovered lifting device 10 does not have a sufficient charge to produce enough working gas to lift a pot 11 from a deployed position, the user may press inward on the release button 55 a sufficient distance that the lift bag chamber 24 and the valve actuator may be removed from the body tube 22 of the lifting device 10. The tank 35 may then be removed from the body tube 22 for recharging or replacement. The tank 35 or replacement may then be inserted into the body tube 22, and the lifting device 27 may be reassembled with the lift bag 27 stowed in the lift bag chamber 24 and, as desired, with a portion of the lanyard 43 being stowed therein as well. The lifting device 10 may then be attached to another object, such as a pot 11, for redeployment to a seabed, lake bed or the like.

It should be noted that the option exists to redeploy the lifting device 10 even if the tank 35 will not be able to generate sufficient working gas to fill the lift bag 27 to lift the pot 11, or other attached object, to the surface. In such case, the pot 11 may still be lifted to the surface by hand with the lift bag 27 providing lift in accordance with the quantity of working gas the tank 35 was able to supply. Positive buoyancy may even be achieved as the pot 11 is raised from the bottom and the working gas in the partially-filled lift bag 27 expands with the lessening water pressure as the pot 11 is drawn up. Depending on the amount of working gas, the lift bag may even achieve positive buoyancy for the lifting device 10 and pot 11 before it reaches the surface.

It will be recognized by those skilled in the art that a variety of tanks are available with a variety of different valving arrangements. A tank 35 with a side valve might require a modification of the gas release mechanism, such as, for example, the use of a lever or cam to convert upward pull on the lift line 13 to a force that could open the valve. According to embodiments disclosed above, the valve is operated when the lifting force is applied to the lift line 13 that applies an upward force on the lifter 34 that pushes the valve stem 38 into engagement with the valve actuator 37. The same type lifter 34 might lift a tank 35 with a side valve so that a lateral pressure is applied to the stem 38 by a cam or inclined surface or other actuator as the tank 35 is lifted. Other valve arrangements may require other such measures to achieve release of a working gas into a lift bag 27 in response to tension on the lift line.

Although the present invention has been described in considerable detail with reference to certain embodiments, other embodiments are possible. Therefore, the spirit or scope of the appended claims should not be limited to the description of the embodiments contained herein.

I claim:

1. A lifting device for lifting an object submerged in a body of water, and attachable to a lift line extendable from the surface of the body of water, the lifting device comprising:
an attachment structure attachable to an object to be submerged;
a gas generator having a valve actuatable to release a working gas;
a gas release mechanism comprising a valve actuator and an operating force applier, the force applier applying a valve operating force between the valve actuator and the valve to cause the gas generator to release a working gas, at least one of the gas generator and the gas release mechanism being attached to the attachment structure;
a connector connected to the gas release mechanism and connectable to a lift line for transmitting an operating force to the force applier; and
a gas receptacle connected to the attachment structure for receiving and retaining at least a portion of the working gas.

2. The lifting device of claim 1 wherein the gas generator comprises a tank having a valve at one end for containing a working gas.

3. The lifting device of claim 2 wherein the working gas is carbon dioxide.

4. The lifting device of claim 2 wherein the operating force applier comprises a lifter for applying the valve operating force to the tank.

5. The lifting device of claim 4 wherein the connector comprises a lanyard having at least two legs, the lanyard being connected to the lifter for transmitting valve operating force thereto, the lanyard being connectable to a lift line.

6. The lifting device of claim 5 wherein the gas receptacle comprises a lift bag releasably connected to the valve actuator.

7. The lifting device of claim 6 wherein the attachment structure comprises a housing, the housing containing the valve actuator, lifter, tank and lift bag, the lift bag being connected to the housing and the housing being attachable to the submerged object.

8. The lifting device of claim 7 wherein the valve actuator is connected to the housing, and wherein the lifter is positioned beneath the tank, and further wherein the connector comprises a lanyard attached to the lifter for applying a lifting force thereto to urge the valve of the tank into gas-releasing engagement with the valve actuator.

9. A method of raising a submerged object to the surface of a body of water comprising the steps of:
attaching a lifting device to the object;
attaching one end of the lift line to the lifting device;
submerging the object, lifting device and the one end of the lift line in a body of water while maintaining the other end of the lift line at the surface of the body of water;
causing the lifting device to emit a quantity of gas in response to tension applied to the lift line at the surface of the body of water;
capturing a portion of the released gas in a gas receptacle connected to the submergible object sufficient to create buoyancy in the gas receptacle to raise the object to the surface of the body of water.

10. The method of claim 9 wherein the tension applied to the lift line causes the emission of gas by causing operation of a valve on a tank containing a compressed gas.

11. An apparatus for raising an object from a submerged position in a body of water comprising:
attachment means attachable to an object to be raised;
generating means for generating a quantity of working gas;
actuating means for actuating the generating means to release the quantity of gas, at least one of the generating means and actuating means being connected to the attachment means;
receptacle means forming a receptacle for capturing gas released by the gas generating means, the receptacle means being attached to the attachment means; and
connector means connected to the actuating means and attachable to a lift line for applying an operating force to the actuating means in response to a lifting force applied to a lift line connected thereto.

12. The apparatus of claim 11 wherein the generating means comprises a tank for containing a compressed gas, the tank having a valve operable by application of pressure to a valve stem.

13. The apparatus of claim 11 wherein the receptacle means comprises a lift bag connected to the attachment means and having an open lower end to receive working gas generated from the generating means.

14. The apparatus of claim 11 wherein the actuating means comprises a gas releasing mechanism for urging the valve of the tank into engagement with a valve actuator.

15. The apparatus of claim 11 wherein the gas releasing mechanism further comprises a lifter and wherein the connector means comprises a lanyard connected to the lifter, the lifter is engagable with the tank to receive a tension applied to the lanyard by a lift line and to transmit that tension to a raise the tank into gas-releasing engagement with the valve actuator.
